(19) United States
(12) Patent Application Publication
(10) Pub. No.: US 2022/0164423 A1
(43) Pub. Date: May 26, 2022

(54) METHOD AND APPARATUS FOR USER RECOGNITION

(71) Applicant: Wallife s.r.l., Roma (IT)

(72) Inventors: Umberto CALLEGARI, Roma (IT); Massimo CAPOZZA, Roma (IT); Fabio SBIANCHI, Roma (IT)

(21) Appl. No.: 17/530,726

(22) Filed: Nov. 19, 2021

(30) Foreign Application Priority Data
Nov. 20, 2020 (GB) 2018306.7

(51) Int. Cl. G06F 21/31; G06N 20/00

(52) U.S. Cl. CPC G06F 21/316; G06N 20/00

(57) ABSTRACT

Computer recognition is performed to recognise whether a user interacting with a user device in an identified interval of time is the same user as a user that has interacted with the device at other times. First user behaviour data is derived by processing first data representative of a user interacting with the user device, generated by a plurality of different elements of the user device including a sensor. At least a first interval of time is identified relating to an interaction of a user with the user device. Second user behaviour data is derived by processing second data representative of a user interacting with the user device during at least the first interval of time. User verification data, based on the first user behaviour data and the second user behaviour data, is transmitted from the user device to an interaction verification system.

### CROSS-REFERENCE TO RELATED APPLICATIONS

This application claims priority to GB Application No. GB 2018306.7, filed Nov. 20, 2020, under 35 U.S.C. § 119(a). The above-referenced patent application is incorporated by reference in its entirety.

### BACKGROUND

### Technical Field

The present invention relates a method and apparatus for user recognition and in particular, but not exclusively, to a computer-implemented method for enabling computer recognition of whether a user interacting with a user device in an identified interval of time is the same user as a user that has interacted with the device at other times.

### Background

Many interactions between a user and a user device may require verification. For example, an interaction may involve using application software on a user device such as a mobile phone or computer to verify a user's identity, for example for authorising entry to a building or vehicle, or to carry out any process requiring user recognition. Conventionally, an interaction of a user with a user device is verified at the time of the interaction. For example, facial recognition and/or fingerprint recognition may be used to verify a user's identity, and if the verification fails, the interaction may be declined. In the event of successful verification, the verified interaction may continue. However, the reliability of the verification is typically not 100%, and the user during a given interaction may not be the intended user.

### SUMMARY

In accordance with a first aspect of the invention there is provided a computer-implemented method for enabling computer recognition of a user interacting with a user device in an identified interval of time by processing data at the user device to produce user verification data for use in an interaction verification system, comprising:
deriving first user behaviour data by processing a first plurality of sets of data, each of which is generated by a plurality of different elements of the user device, the plurality of different elements including at least one sensor, and each of which is representative of a user interacting with the user device;
identifying at least a first interval of time relating to an interaction of a user of the user device with the user device;
deriving second user behaviour data by processing a second plurality of sets of data, each of which is generated by the plurality of different elements of the device, the plurality of different elements including at least one sensor, and each of which is representative of a user interacting with the user device during at least the first interval of time; and
transmitting user verification data, based on the first user behaviour data and the second user behaviour data, from the user device to the interaction verification system.

This allows the interaction verification system to process the verification data to determine a probability that the user interacting with the user device in the first interval of time is the same user as a user that has interacted with the device at times relating to the first plurality of sets of data.

In an example, the method comprises identifying the first interval of time as an interval of time during which the interaction occurs.

This allows the second user behaviour data to relate to behaviour of the user in performing the interaction.

In an example, the method comprises identifying a second interval of time as an interval of time before which the interaction occurs and/or
identifying a third interval of time as an interval of time after which the interaction occurs,
wherein the second plurality of sets of data is each representative of a user interacting with the device during the first interval of time and the second and/or the third interval of time.

This allows the second user behaviour data to better represent user behaviour, on the assumption that the user is the same for the first, second and third intervals of time.

In an example, the method comprises collecting the second user behaviour data in response to receiving an indication that an interaction is in progress.

This allows data to be collected that is appropriate for the time of the interaction.

In an example, the method comprises:

storing the second user behaviour data in a storage system on the user device;

receiving timing data indicative of the first interval of time from the interaction verification system; and
retrieving the second user behaviour data from the storage system on the basis of the timing data.

This allows data relating to a disputed interaction to be identified and retrieved for use in processing by the interaction verification system.

In an example, deriving the first and second user behaviour data comprises use of a hardware abstraction functional module configured to transform data generated by the plurality of different elements of the user device into transformed element data having a normalised format.

The generation of transformed element data having a format normalised allows the interaction verification system to process data without regard to the characteristics of a specific user device.

In an example, deriving the first and second user behaviour data comprises use of a data processing functional module configured to perform summarisation, aggregation and combination functions on the transformed element data to generate processed element data.

This allows raw data collected to be transformed into processed data, typically summarised and compressed, for use in a user behaviour functional module.

In an example, deriving the first user behaviour data comprises use of a user behaviour functional module configured to extract information about typical behaviour of a user from processed element data relating to the first plurality of sets of data.

This allows extraction of information from the processed data about the way the user typically operates the device used to carry out the interaction.

In an example, deriving the second user behaviour data comprises use of a behaviour functional module configured to extract information about the behaviour of a user from processed element data relating to the second plurality of sets of data.

This allows user behaviour information to be extracted relating to a certain period of time, typically before, during, and after an interaction is made.

In an example, the user verification data comprises an output from a machine learning model.

In an example, parameters for the machine learning model are received from the validation system.

In an example, an input to the machine learning model comprises the first user behaviour data and the second user behaviour data and the user verification data comprises an output of the machine learning model.

In an example, the output of the machine learning model comprises a probability that a user in the first interval of time is different from a user corresponding to the first user behaviour data. The machine learning model may be a deep neural network, DNN, which has been trained to detect an anomalous interval of time in a series of intervals of time. For example, the machine learning model may be trained by supervised learning using a sequence of sets of user behaviour data, most of which are known to be from a given user and one or more of which are known to be from a different user.

Alternatively, an input to the machine learning model may comprise at least the first set of data and the second set of data and an output of the machine learning model comprises the first user behaviour and the second user behaviour data. In an example, the machine learning model has been trained by using unsupervised learning to sort interactions in trial data into clusters. The machine learning model may process individual time intervals to estimate to which cluster the time interval belongs, and the user verification data may comprise an estimate of to which cluster the time interval belongs. This allows the interaction verification system to compare which cluster the first time interval belongs in comparison with the cluster of clusters to which time intervals corresponding to the first data belong.

In accordance with a second aspect of the invention there is provided a user device comprising a processor configured to perform the method for enabling computer recognition of a user interacting with a user device in an identified interval of time by processing data at the user device to produce user verification data for use in an interaction verification system.

In accordance with a third aspect of the invention there is provided a computer program comprising instructions which, when the program is executed on a computer, causes the computer to carry out the steps of the computer-implemented method for enabling computer recognition of a user interacting with a user device in an identified interval of time by processing data at the user device to produce user verification data for use in an interaction verification system.

In accordance with a fourth aspect of the invention there is provided a non-transitory computer-readable storage medium holding instructions for causing one or more processors to perform the steps of the computer-implemented method for enabling computer recognition of a user interacting with a user device in an identified interval of time by processing data at the user device to produce user verification data for use in an interaction verification system.

In accordance with a fifth aspect of the invention there is provided a system for verification of an interaction after the interaction has taken place, comprising the user device and the interaction verification system. Typically, the interaction verification system is configured to process the user verification data to provide a verification of a given interaction.

In an example, the interaction verification system comprises a customer and end user profile module configured to store the user verification data.

This allows the interaction verification system to verify an interaction in the absence of a current connection to the user device.

In an example, the interaction verification system comprises an interaction validation module configured to provide an estimate of the probability that a given interaction involved a given user by processing of the user verification data.

This may allow the interaction verification system to confirm, or not to confirm, that a disputed interaction was actually a case of fraudulent authentication with a certain degree of confidence.

In an example, the interaction verification system comprises a data processing module configured to determine data processing rules to be applied by the user device, and to send data indicating the data processing rules to the user device.

This allows determination of data processing rules, which is typically demanding of data processing capacity, to be carried out in a processor outside the user device, and furthermore the rules may be developed, for example by using artificial intelligence techniques, based on data from more than one device. The interaction verification system may comprise a machine learning model for use in determining parameters for use in a corresponding machine learning model for a user device.

Further features and advantages of the invention will become apparent from the following description of examples of the invention, which is made with reference to the accompanying drawings.

### BRIEF DESCRIPTION OF THE DRAWINGS

In order that the present invention may be more readily understood, examples of the invention will now be described, with reference to the accompanying drawings, in which:

FIG. 1 is a schematic diagram showing a plurality of user devices in communication with an interaction verification system;

FIG. 2 is a schematic diagram showing a user device configured to process data to generate user verification data to be sent to an interaction verification system;

FIG. 3 is a schematic diagram showing an interaction verification system for processing user verification data received from at least one user device;

FIG. 4 is a schematic diagram showing a system comprising a user equipment and an interaction verification system;

FIG. 5 is a schematic diagram showing a system comprising a user equipment and an interaction verification system, using a machine learning model in the user device to generate first and second user behaviour data;

FIG. 6 is a schematic diagram showing a system comprising a user equipment and an interaction verification system, using a machine learning model in the user device to generate user verification data;

FIG. 7 illustrates training of a machine learning model at the interaction verification system;

FIG. 8 illustrates sending machine learning model parameters from the interaction verification system to a machine learning model in each user equipment;

FIG. 9 illustrates signal flow in a machine learning model comprising a deep neural network;

FIG. 10 illustrates an example of a training method of a deep neural network during training and deployment phases;

FIG. 11 is a collaboration diagram showing the activation of a new user;

FIG. 12 is a collaboration diagram showing the performance of further user initialisation functions;

FIG. 13 is a collaboration diagram relevant to a disputed interaction;

FIG. 14 is a block diagram showing a backend system arrangement which is dedicated to a customer;

FIG. 15 is a block diagram showing a backend system arrangement which is shared among multiple customers; and

FIG. 16 is a flow diagram showing a method of processing data in a user device to generate user verification data for use in an interaction verification system;

### DETAILED DESCRIPTION

Examples of the invention are described in the context of a system for verification of an interaction after the interaction has taken place. The example of an interaction with a biometrical identification system is described, for access to a building or a vehicle, but it will be understood that the invention is not limited to these examples, but may relate to verification of other interactions, such as authentication of identity for validation of a financial transaction, or any interaction with the user device in which it is required to verify whether a user interacting with a user device in an identified interval of time is the same user as a user that has interacted with the device at other times. User verification data is generated at the user device from sensors and other elements of the user device, representing user behaviour during an interaction and during interactions at other times and is sent to an interaction verification system. In this example, the interaction verification system provides a second level of identification in addition to an existing biometrical identification system, so that, in the case a first-level identification event is disputed, the second level provided by the system can be used to ascertain whether the first-level identification was incorrect or anomalous, such as in the cases of fraudulent impersonation, simulated fraudulent impersonation, or coercive authentication.

In one example, an interaction in the form of a user authentication using fingerprint recognition is verified, with the verification based on user behaviour data derived from an inertial sensor in the user device. A user may make a characteristic series of movements when using the fingerprint sensor, which may be detected using the inertial sensor or accelerometer. Movements measured in three or more axes (e.g., acceleration plus angular speed may be regarded as a six-axes inertial system) may be recorded before, during and after the interaction with the fingerprint sensor. User behaviour data for an identified interaction may be compared with user behaviour data for interactions recorded at other times. In addition to data from an initial sensor, the user behaviour data may be based on data from one or more cameras and/or radio frequency sensors. The camera and radio frequency sensors provide further data representing the background environment as part of the user behaviour, such as ambient light conditions and colour, and typical radiofrequency signal level. The inertial sensors, cameras and radiofrequency sensors may also be used to generate user behaviour data for verification of facial and voice detection, for example.

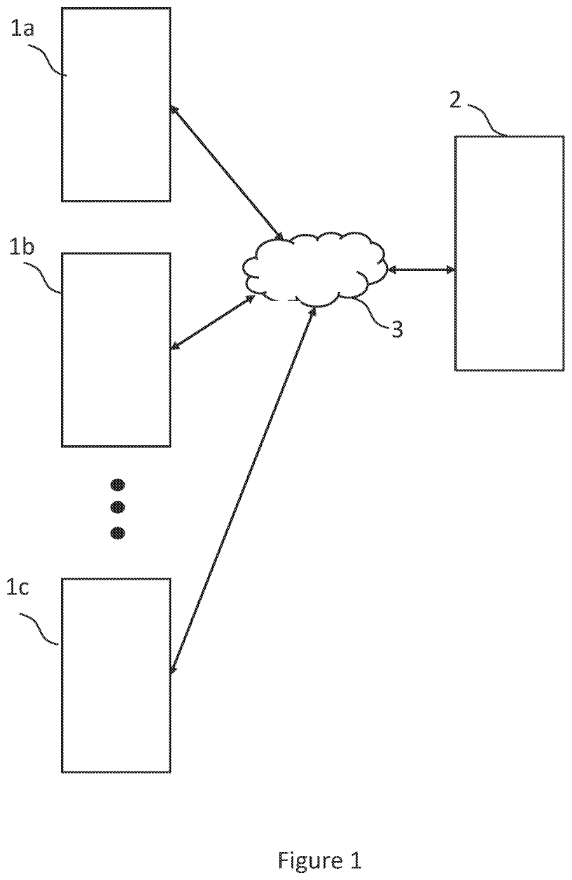

As shown in FIG. 1, the system comprises one or more user devices 1a, 1b, 1c, such as, for example, a mobile phone or a computer, configured to generate user verification data, and an interaction verification system 2, which is typically implemented by data processing outside the user device, which may be referred to as “backend” data processing. The backend processing may be implemented in a data processor at a central office, or may be implemented by distributed or cloud processing. The one or more user devices 1a, 1b and 1c are shown in communication with the interaction verification system 2 via a data network 3. The data network may comprise a cellular wireless network and other data connections.

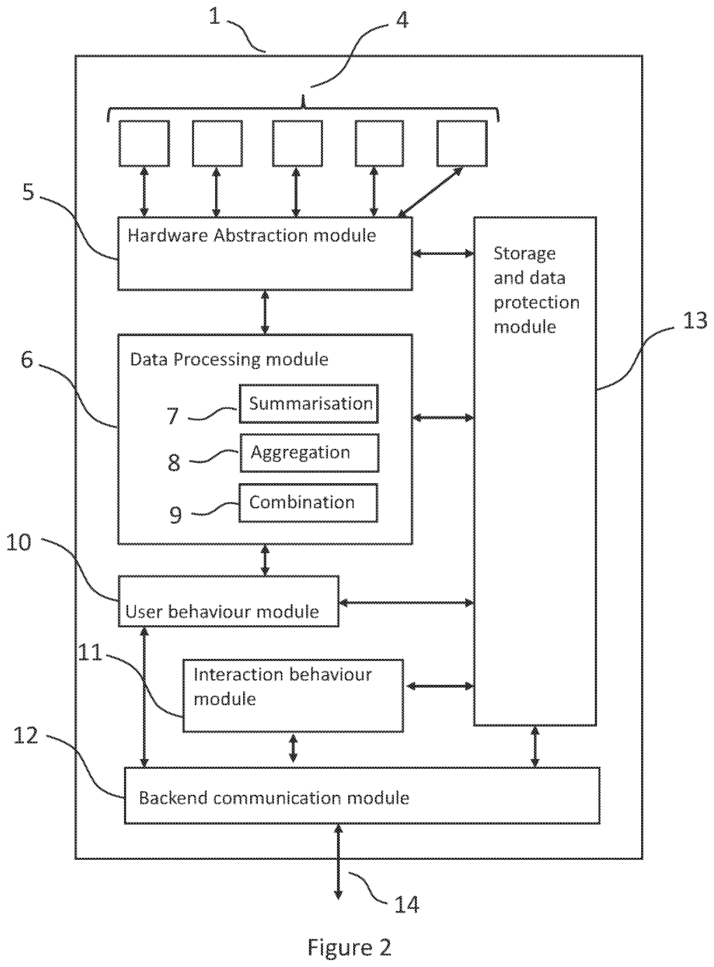

FIG. 2 is a schematic diagram showing a user device 1 configured to process data to generate user verification data for use in an interaction verification system. As shown in FIG. 2, the user device has multiple different elements 4 which are used to generate a plurality of sets of data from which first user behaviour data is derived. Each set of data is representative of a user interacting with the user device.

The elements may be, for example, sensors of the user device, such as one or more of a camera, a microphone, an inertial sensor, a temperature sensor, a fingerprint sensor, a keyboard, a touchpad and a mouse. One or more of the elements may comprise a radio interface of the device, such as a WiFi interface, a positioning system interface such as a GPS/GNSS interface, a Bluetooth interface, a cellular wireless interface and a contactless interface such as an NFC interface. The elements may comprise a wired interface, such as a USB interface. The elements may also comprise a screen interface, a touchscreen interface, a loudspeaker or earphones interface, an operating system and a timer. In each case, this allows data to be derived that is representative of user interaction involving one or more of the elements. Peripheral interfaces used for identification, for example the keyboard if the identification requires to enter a username and password, may be regarded as specific types of sensors.

The user device 1 is configured to derive first user behaviour data from a first plurality of sets of data, each of which is generated by at least some of the plurality of different elements 4 of the user device. In a first example, user behaviour data is derived from the outputs of a fingerprint sensor and an inertial sensor. In a second example, the user behaviour data is derived from the outputs of an inertial sensor and a camera. In a third example, the user behaviour data is derived from the outputs of an inertial sensor, a camera, and keyboard output as a function of time.

The user device is configured to identify at least a first interval of time relating to an interaction involving a user of the user device, and to derive second user behaviour data from a second plurality of sets of data, each of which is generated by the plurality of different elements of the device, and each of which is representative of a user interacting with the user device during at least the first interval of time. Identifying at least the first interval of time may comprise receiving from an interaction verification system an indication identifying at least the first interval of time. For example, the indication may be an indication of a time of a queried or disputed interaction. The first interval of time may be a time during which a fingerprint or facial recognition authentication takes place, for example.

As shown in FIG. 2, the user device comprises hardware abstraction functional module 5, a data processing module 6, a user behaviour module 10 and an interaction behaviour module 11. The hardware abstraction functional module 5, the data processing module 6 and the user behaviour module 10 are used to derive the first user behaviour data, and the hardware abstraction functional module 5, the data processing module 6 and the interaction behaviour module 11 are used to derive the second user behaviour data.

The hardware abstraction functional module 5 is used to derive the first and second user behaviour data by transforming data generated by the plurality of different elements 4 of the user device into transformed element data having a format normalised for the interaction verification system. This allows the interaction verification system to process data without regard to the characteristics of a specific user device. The data processing functional module 6 has summarisation 7, aggregation 8 and combination 9 functional blocks. These operate on the transformed element data to generate processed element data. This allows raw data collected to be transformed into processed data, typically summarised, for use in a user behaviour functional module.

The hardware abstraction module 5 transforms data from the user device elements into a common, normalised format that is compatible for user devices enabled to perform the interaction verification. For example, different user devices may have different camera resolution specifications, and the hardware abstraction module takes care of transforming data from the camera to provide data that is compatible, regardless of the specific user device, with the other functional modules that have to gather, process, and store the data.

The data processing module 6, based on data received from the hardware abstraction module 5, transforms the raw data collected into multiple levels of processed data. Its data processing functions may be divided into three main classes: summarisation; aggregation; and combination. Such functions may be performed by means of programmed computing algorithms as well as through artificial intelligence functions, such as machine learning models. This module also acts as the counterpart, on the user device side, of the corresponding module 17 present on the backend side, that is to say the interaction verification system 2. The data processing module 6 may be referred to as the data processing and artificial intelligence module.

The user behaviour module 10, based on data provided by the data processing module 6, extracts information about the way the user typically operates the user device. The information, conveyed in the first user behaviour data, may relate to an identifier of the device, how much and when it is used during the day and during the week. The information may also relate to behaviour related to pressing keys or swiping, for example using one or two hands to enter data. The information may also relate to applications most frequently used, or for example locations where the user device is used.

The interaction behaviour module 11, based on data provided by the data processing module 6, extracts detailed user behaviour information for a certain period of time before, during, and/or after an interaction is made. The purpose is similar to the user behaviour module 10, however it is specifically focused on the way the user operates the device during interactions related to the customer. The interaction behaviour module 11 provides the second user behaviour data.

An interaction recording module may record data associated with an interaction, such as screenshots, keystrokes, video, sound, and fingerprint authentication for example to document the occurred interaction in detail. The recording may be activated at different levels of detail, for example the level of detail of raw data or data processed by the data processing module 6 may depend on technical as well as regulatory, for example privacy, constraints.

A storage and data protection module 13 stores the collected data on the user device memory taking into account any technical and/or regulatory constraints, for example privacy, that may limit the quantity and/or the type of data that can be retained. It also aims at protecting the data from corruption or deletion, which the end user or an unauthorised user may attempt to perform in the case of a simulated or not simulated fraudulent impersonation.

A backend communication module 12 allows communications with the backend system, that is to say the interaction verification system. It may also manage technical and/or regulatory constraints that limit the quantity and/or the type of data that can be transferred from the user device to the backend. The backend communication module 12 transmits user verification data 14, based on the first user behaviour data and the second user behaviour data, from the device to an interaction verification system. The user verification data may comprise the first user behaviour data and the second user behaviour data. Alternatively, the user verification data may comprise data derived by processing the first user behaviour data and the second user behaviour data. For example, the user verification data may be an output from a machine learning model, for which the first user behaviour data and the second user behaviour data is an input.

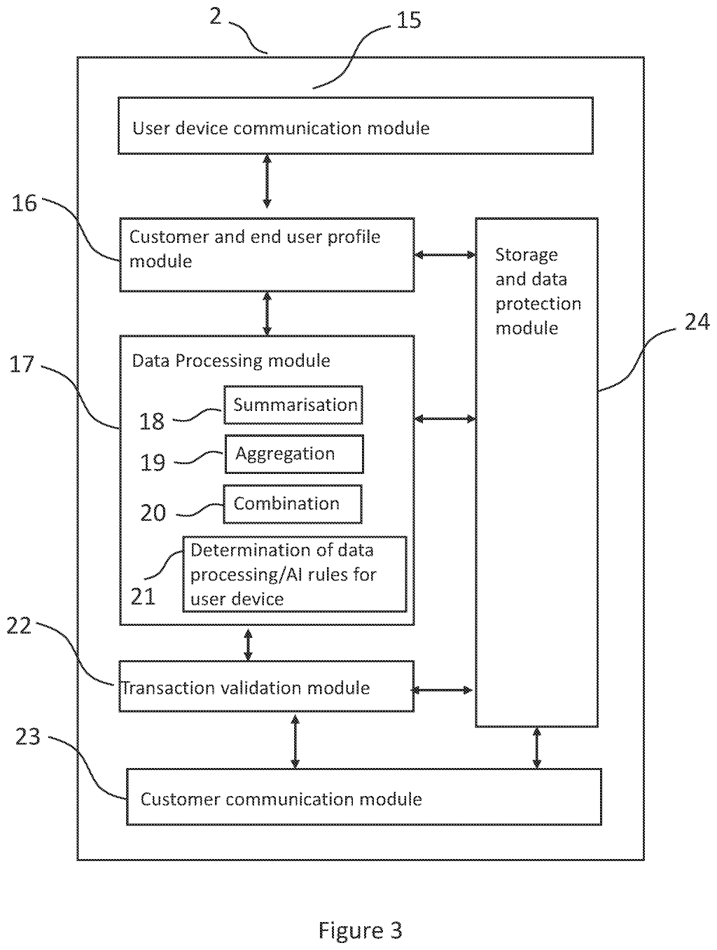

FIG. 3 is a schematic diagram showing an example of the interaction verification system 2. The interaction verification system 2 is configured to process the user verification data, which may comprise the first user behaviour data and the second user behaviour data, received from the user device 1, to provide a verification of a given interaction.

As can be seen in FIG. 3, the interaction verification system comprises a user device communication module 15 to allow receipt of the user verification data from the user device, and a customer and end user profile module 16 configured to store the user verification data.

The interaction verification system 2 comprises a data processing module 17, comprising modules for summation 18, aggregation 19, and combination 20 of data, and comprising a module for determination of data processing rules 21, such as parameters for a machine learning model, which may be determined as part of an artificial intelligence system. The data processing module 17 is configured to determine data processing rules to be applied by the user device 1, and to send data, via the user device communication module 15, indicating the data processing rules to the user device 1.

The interaction verification system comprises an interaction validation module 22 configured to provide an estimate of the probability that a given interaction involved a given user by processing of the first and second user behaviour data.

The user device communication module 15 mirrors, on the backend side, the communication module present on the user device, so it takes care of communications with the user device.

The customer and end user profile module 16 stores information concerning the customer and the end user that are pursuant to the interaction verification, such as, for example, the quantity and/or type of data that can be stored and transferred to the backend in compliance with privacy consent accepted by the end user.

The storage and data protection module 24 stores on the backend the collected data after they are transmitted by the user device to the backend, taking into account technical and/or regulatory constraints that may require to limit the quantity and/or the type of data that can be retained.

The data processing module 17, which may include artificial intelligence functions, and may be referred to as the data processing and artificial intelligence module, may perform on the backend side the same functions, that is to say summarisation, aggregation and combination, of the corresponding module on the user device side whenever, for example, the required data on the user device are not available any more, while a copy of such data remains available on the backend side. However, this module on the backend side determines the data processing and/or AI rules, such as parameters for a machine learning module, that the corresponding module on the user device side has to apply. The rules are determined centrally and then the actual application of the rules is delegated to the user device.

The interaction validation module 22 is a module that may confirm whether or not a disputed interaction was actually a case of fraudulent authentication, simulated or not simulated, with a certain degree of confidence.

The customer communication module 23 implements the interface between the customer's IT systems and the interaction verification backend, where the customer may request that an interaction verification is performed on a disputed interaction, and the customer receives the result of the check as provided by the interaction validation module. The customer is an entity that requires the verification of the interaction. The interaction may be an interaction carried out by the user through the user device, and may comprise an authentication of the user.

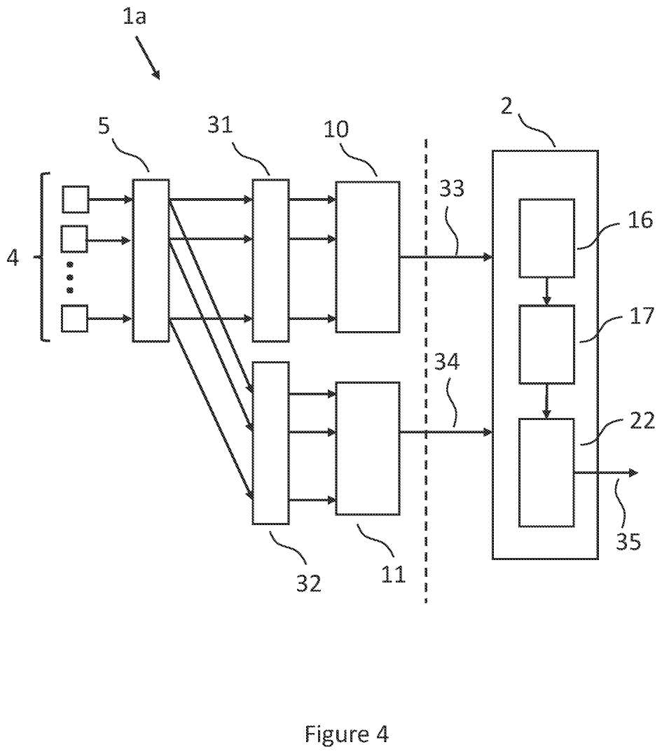

FIG. 4 is a schematic diagram showing an example of a system comprising a user equipment 1a and an interaction verification system 2. As shown in FIG. 4, data from hardware elements 4 including at least one sensor is processed by hardware abstraction module 5 to produce first abstracted data 31 relating to times other than a first interval of time associated with a given interaction, and second abstracted data 32 relating to the first interval of time associated with a given interaction. The first abstracted data 31 is processed by the user behaviour module 10 to produce first user behaviour data 33 and the second abstracted data 32 is processed by the interaction behaviour module 11 to produce second user behaviour data 34. User verification data, in this case comprising the first user behaviour data 33 and the second user behaviour data 34, is sent to the interaction verification system 2. At the interaction verification system 2, the user verification data is processed by a customer and end user profile module 16, a data processing module 17 and an interaction validation module 22. This produces an output 35, which may be an indication of a probability that whether a user interacting with a user device in an identified interval of time is the same user as a user that has interacted with the device at other times.

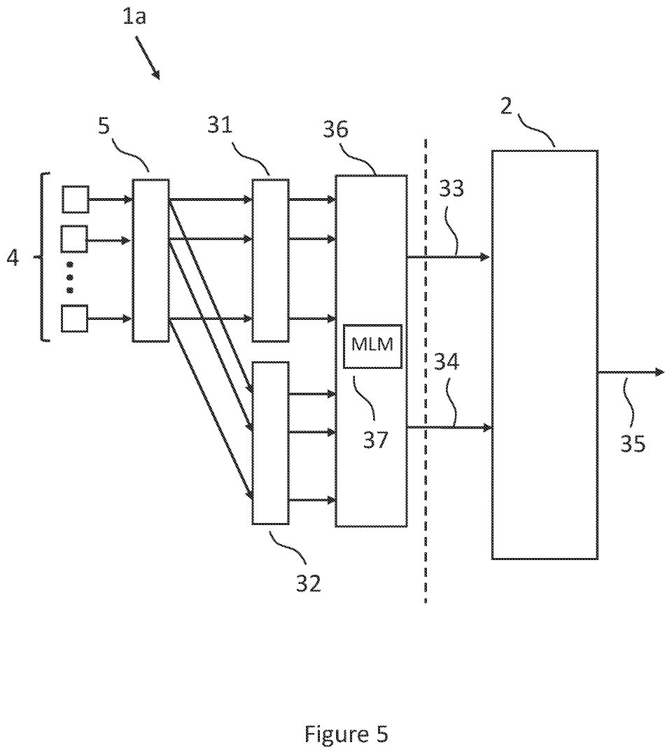

FIG. 5 is a schematic diagram showing a system comprising a user equipment 1a and an interaction verification system 2, using a machine learning model 37 running on a processor 36 in the user device to generate first and second user behaviour data 33, 34. The first and second user behaviour data 33, 34 may be processed in the interaction verification system to produce an output 35, which may be an indication of a probability that whether a user interacting with a user device in an identified interval of time is the same user as a user that has interacted with the device at other times.

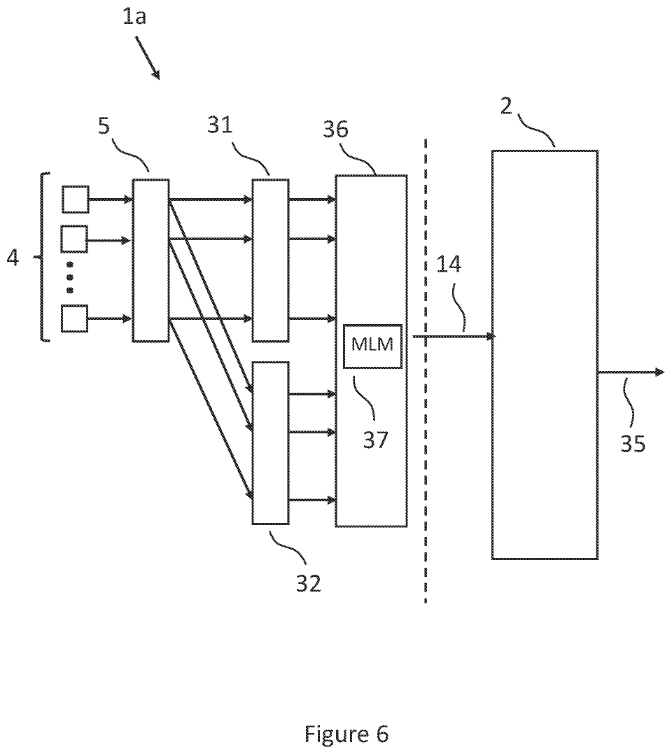

FIG. 6 is a schematic diagram showing a system comprising a user equipment and an interaction verification system, similar to that of FIG. 5, except the machine learning model 37 in the user device generates user verification data 14, which in this example does not comprise the first and second user behaviour data. In this example, the first and second user behaviour data is input to the machine learning model.

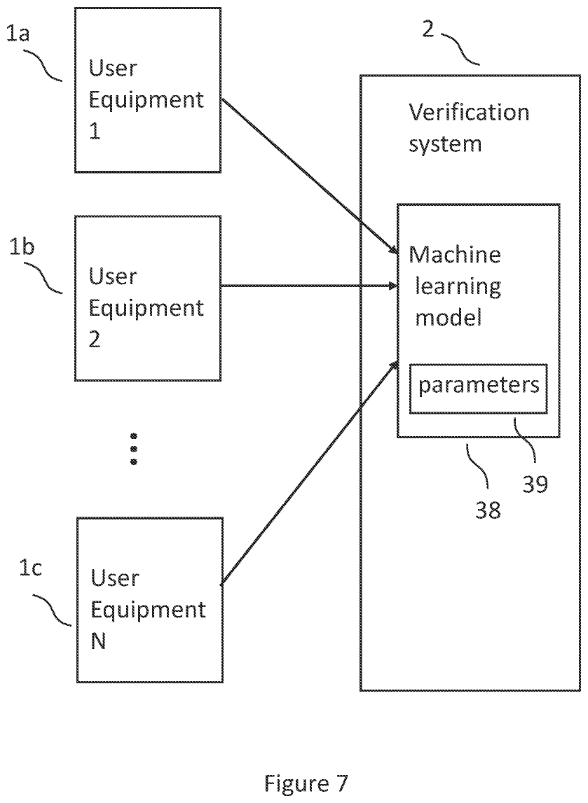

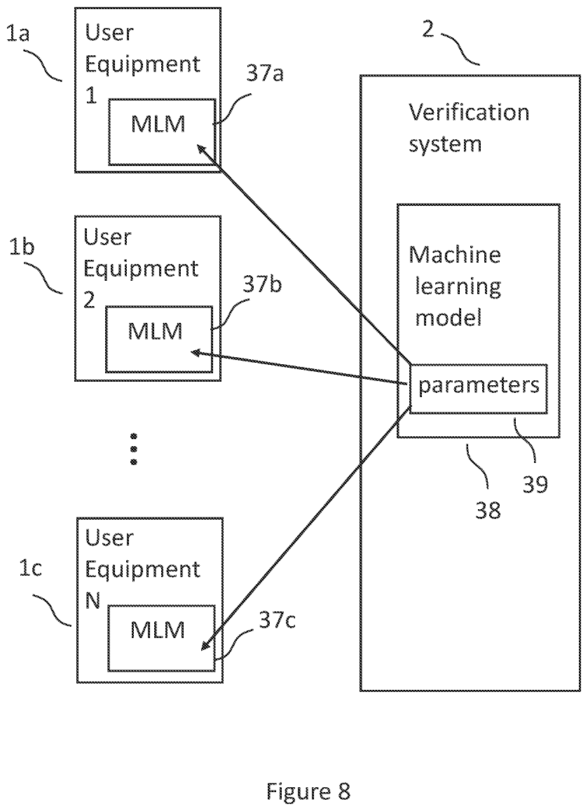

FIG. 7 illustrates training of a machine learning model 38 at the interaction verification system. The machine learning model 38 at the interaction verification system has similar features to the machine learning model 37 in a user device, so that parameters learned on the machine learning model 38 at the interaction verification system can be used for the machine learning model 37 in a user device. FIG. 8 illustrates sending machine learning model parameters from the interaction verification system to a machine learning model in each user equipment.

As shown in FIG. 8, there may be a machine learning model (such as a neural network model, which may be conventionally referred to as a deep neural network (DNN)), at each user device 1a, 1b, 1c, and a duplicate at the back end system 2. The machine learning model at the back end system may be trained before deployment of the live system using trial data. The parameters (such as weights in the case of a DNN) for the machine learning model resulting from the training may then be sent for loading onto the machine learning model of the user devices. This allows the trial data to be obtained in circumstances in which privacy issues may be less of a constraint. If privacy requirements allow, then it may be possible to train the machine learning model using data from the live system. Updated weights may be periodically sent to the user device for use in the machine learning model at the user device. There is typically a training phase and a deployment phase. In the training phase, a machine learning model at the back end is trained with example data from a large numbers of example users, not necessarily including the eventual end user of a deployed system.

In a first example, a DNN is trained by feeding it data in batches, each batch including data representing a number of interactions, most of which are from a given user for that particular batch, but one or more interactions may be included from a different user. This different user represents a fraudulent interaction. A large number of batches of this type would need to be assembled for the training phase, using various combination of data from trial participants. For each batch, one trial participant is designated as the legitimate user and any other trial participants from which interactions are included in the batch are designated as fraudulent users.

The DNN generates a probability, for each of the interactions of the batch, that the interaction is an anomaly, i.e. from a different user. During training, the known anomalies are labelled with a probability of 1 and the known legitimate interactions are labelled with a probability of 0. The DNN is trained by a process of supervised learning, used to update parameters of the DNN to minimise loss function characteristics of the disparity between labelled probabilities and predicted probabilities. In this way, the DNN is trained to accept data corresponding to a series of interactions, and to generate a probability that each of them is an anomaly, i.e. fraudulent. The DNN may be configured to accept the data corresponding to the series of interactions simultaneously (i.e. with different inputs of the DNN receiving data for different interactions), or the DNN may be configured to receive the data corresponding to the series of interactions in a serial manner (for example using a recurrent neural network (RNN) architecture or a bidirectional RNN architecture). The parameters (weights) of the DNN are not user-specific. The DNN is trained to detect an anomaly in a series of interactions, and the accuracy of the detection should improve as the training progresses over a large number of data sets. The data would be appropriately formatted and processed data from the various sensors of the device. The user interaction data 14 sent to the interaction verification system 2 may comprise data relating to a probability that each interaction is an anomaly. If applying the second user behaviour data to the machine learning model indicates that there is a high probability that the interaction represented by the data is an anomaly and applying the first user behaviour data to the machine learning model indicates that there is a low probability that the interaction represented by the data is an anomaly, this would be indicated by the user interaction data. The user verification system processes the user interaction data to determine whether a user interacting with a user device in an identified interval of time is the same user as a user that has interacted with the device at other times, as represented by the first user behaviour data.

The input data for a “interaction” could in some cases be representative background data for a period of time, not necessarily an actual interaction. However, in some cases, for example the case of the fingerprint sensor and accelerometer combination, the appropriate data would be for an actual interaction involving the fingerprint sensor.

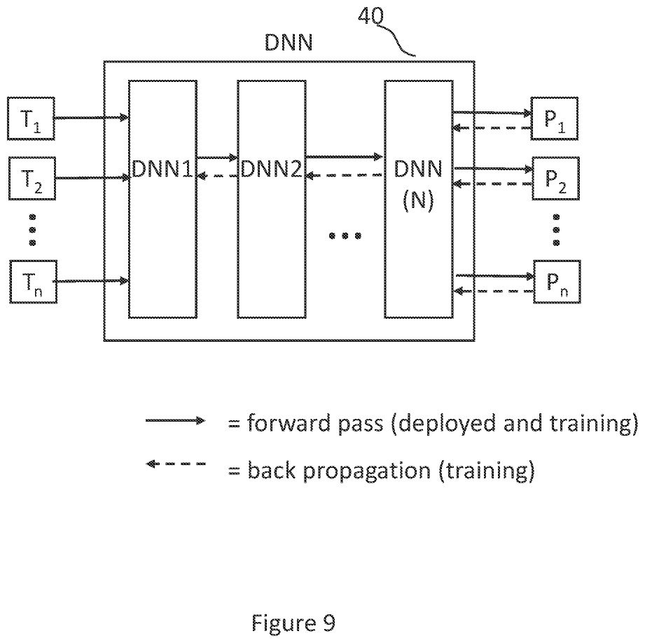

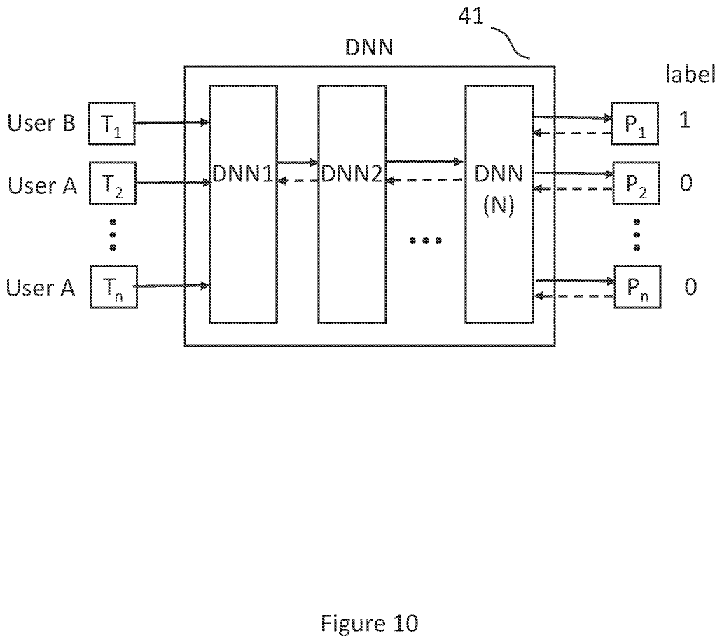

FIGS. 9 and 10 illustrate the first example. A batch of training data is shown as inputs T₁-Tₙ, in which T₁ is data for an interaction for user 1, and so on. Each batch of training data Tₙ may comprise sets of data derived from the outputs of several elements of the device, for example outputs of a fingerprint or facial recognition device, an inertial sensor and a camera, and/or a radiofrequency sensor.

For each of the interactions, a probability of the interaction being an anomaly is generated. is shown as outputs P₁-Pₙ, in which P₁ is probability an anomaly for user 1, and so on. The DNN has multiple layers, DNN1 being an input layer and (DNN2 . . . DNN(N)) being hidden layers. The solid arrows represent forward pass data, as would flow during training and in a deployed system. The dashed arrows represent back propagation, during training only.

Each batch of training data Tₙ may comprise sets of data derived from the outputs of several elements of the device, for example outputs of an inertial sensor and a camera as a function of time.

In a second example, a machine learning model is trained using unsupervised learning to sort interactions in trial data into categories. The categories may be so-called clusters, and the machine learning model may implement a clustering algorithm, for example k-means clustering, Gaussian mixture clustering, or DNN-based clustering. By this process, the machine learning model learns to identify clusters of similar interactions, without being told in advance what the categories should be. The machine learning process may separate out the interactions into a number, k, of clusters for example, where the number k may be predetermined or learned from the data. The number of clusters would typically be much lower than the number of users.

When deployed, the machine learning model may process individual interactions to estimate which cluster the interactions belong to. The machine learning model may directly determine which cluster each interaction for a user equipment belongs to, or may generate a probability that each interaction for a user equipment is in each cluster. From this, it may be determined that one of the interactions is in a different cluster or has a high probability of being in a different cluster, so that it is an anomaly. Alternatively, all the interactions may be determined to be in the same cluster or may have a similar probability of being in each cluster, which may be an indication that the same user was involved in each interaction. The user interaction data 14 sent to the interaction verification system 2 may comprise data relating interactions to clusters.

In the first and second examples, the machine learning model could be implemented using standard software libraries and the code would be compiled at the back end before training. Once the machine learning model at the back end is trained, the parameters for the machine learning model would be sent to the user equipment to be loaded onto the user equipment's machine learning model. The deployed machine learning model may be implemented using, for example, firmware or software running a standard GPU processor or other processing means.

In other examples, digital signal processing may be used to implement the data processing module, which may not necessarily be trained by machine learning. The digital signal processing may comprise summarisation 7, aggregation 8, and combination 9 functions operating as follows. The summarisation function transforms the raw data, typically in normalised form, into summaries that maintain some key elements that may be required as inputs by other functional modules. For example, a facial recognition function may capture the raw data originated by a camera and determine whether the face of the person that is using the device corresponds to person “A” rather than to person “B”. As another example, a suitable function may determine whether a certain text on the device was entered by typing with one hand or with both hands, or using certain fingers only for example.

The aggregation function 8 performs statistical analyses on the data, either raw or already summarised, to later identify typical ways of using the device. For example, a function may evaluate the average length of text messages typed on messaging systems, as some users tend to divide a long message into short messages while other users type a single long message instead. As another example, a function may evaluate whether the facial recognition always identifies the same person in front of the device (likely the normal user of the device) or whether the device is frequently used by various people.

The combination function 9 function allows data originated from multiple elements of the user device, for example sensors, either raw or already summarised or aggregated, to be combined into new types of data, which can be then further summarised, aggregated, or combined again. For example, information related to the use of the keyboard, such as typing with multiple fingers or not, swiping, and so on and video data can be combined in such a way that the recognition of the user makes use of both information together.

In general, different levels of data processing, of aggregation, and of combination, also further combined, may exist in order to best serve the other modules with useful information.

The above function may be implemented using two different approaches, which are not mutually exclusive and that may be combined: programmed algorithms and artificial intelligence (AI) algorithms Using programmed algorithms, the outputs, that is the processed data, are computed by applying an automated sequence of statements, mathematical expressions, conditional expressions, etc., that basically correspond to the functions provided by computer programming languages. Using artificial intelligence algorithms, the outputs are the result of applying rules that derive from the experience that the computing system acquires from processing existing datasets previously collected. Machine learning, where the experience from existing training datasets is transformed into data processing rules to be applied to future datasets, may be a component of AI algorithms.

Both approaches make use of rules: in programmed algorithms rules are represented by statements, mathematical expressions, etc., while in an AI context they are represented through different means, such as neural networks having a certain topology and appropriate weights on the connections between the network's nodes. On the user device side, such rules are applied. The corresponding data processing and artificial intelligence module on the backend side is instead mainly devoted to determine the rules to be then applied on the user device side.

The user behaviour module is conceptually an additional data processing/AI module performing further aggregation; however, it is specifically designed to identify the typical ways of using the device throughout the days and weeks. User behaviour indicators are determined, such as the identification of the device use, how much the device is used (e.g.: turned off; idle; charging; messaging; communication by phone; browsing the internet; reading email; etc.) and at what times of the day and on what days of the week this is done, typical lighting and background noise conditions, typical locations visited, determined using GNSS as well as other means (e.g., WiFi SSIDs, Bluetooth devices in the surroundings, etc.), and typical use of the keyboard and mouse (pressing keys or swiping; using one or two hands and/or specific fingers for typing, etc.).

The interaction behaviour module 11 performs similar functions with respect to the user behaviour module 10, however the functions are specifically based on the data collected for a certain period of time before, during, and after an interaction is made. As an interaction may start at any time and it requires the availability of data for a period of time before the interaction begins, a circular memory is used as a buffer to save the data required when the interaction begins. The purpose of this module is to determine the user's behaviour specifically during interactions related to the customer.

In a first scenario, all data collected and stored are sent to the backend as soon as a communication channel to the backend is available. This communication setting is optimum to ensure the maximum availability of data to the backend to perform interaction verifications, even if the user device is destroyed or data are compromised, either by accident or by a deliberate sabotage. However, it might not be possible to use this setting due to regulatory (e.g., privacy) constraints.

In a second scenario, data remain stored in the user device, and only a minimum set of data is transmitted to the backend when a disputed interaction occurs. This communication setting is the safest from a privacy viewpoint, however it is most vulnerable to device damage/sabotage.

The compromise between the above two extremes of the first and second scenarios is implemented by this module, and is controlled, together with all other configuration settings, by the customer and end user profile module present in the backend.

This module also communicates locally (i.e., on the user device) with the customer's application, i.e., with the software running on the user device to perform the interactions. Unique interaction IDs are assigned and shared between the customer's application and the interaction verification system. It also takes care of logging-in the user to the backend systems using a Single Sign On (SSO) procedure, i.e., a single login that works both for the customer's application as well as for the interaction verification features that work in background.

Examples of verification of authentication based on fingerprint recognition, facial recognition, and speaker recognition are as follows, which make use of data from other sensors which is collected and processed.

Verification of Authentication Based on Fingerprint Recognition

Several techniques of fingerprint spoofing are known, which allow the creation of an artificial fingerprint of a real person and the submission to a fingerprint recognition system so as to perform a fraudulent impersonation. These fingerprint spoofing techniques have demonstrated that a fingerprint verification system can be deceived by submitting artificial reproductions of fingerprints made up of various materials, for example silicon and gelatine, to the electronic capture device. These images are then processed as “true” fingerprints, thus causing a possible fraudulent impersonation.

As a consequence of the above, algorithms have been developed, aimed to check the authenticity of the submitted fingerprints. For example, one of the techniques proposed, named “liveness detection”, attempts to measure liveness from characteristics of the fingerprint images themselves by applying image processing algorithms Other techniques have been also proposed. Even though these techniques, when present, help to reduce the probability that a fingerprint spoofing attempt results in a successful fraudulent authentication, no algorithms of this type are 100% reliable yet. So, a residual probability remains that a fraudulent authentication occurs, even when the most sophisticated authenticity check algorithms are used.

A limit of such authenticity check algorithms is that they only consider the characteristics of the fingerprint image in order to determine the authenticity of the submitted fingerprints, without using other sensors that may help to more accurately evaluate whether the fingerprint was submitted by the actual person being recognised or by somebody else who is using a spoofed fingerprint. The term “single sensor fingerprint recognition” may be used to describe systems and algorithms that perform fingerprint recognition, possibly complemented with authenticity check algorithms, and based on data originated from the fingerprint sensor.

A characteristic of the present examples is that data from a single sensor fingerprint recognition system are combined with data originated from other sensors so as to improve the performance of the overall authenticity check whenever the authenticity of a fingerprint recognition is disputed.

As an example, data originated from a single sensor fingerprint recognition system may be combined with data provided by the inertial sensor, which may be referred to as an accelerometer and/or gyroscope, that is present in most modern smartphones and tablets. The algorithm envisaged to combine data from both sensors is as following.

Raw data from the inertial sensor (3-axes acceleration and/or 3-axes angular speed) are continuously collected and stored in a circular memory that is large enough to store several seconds of raw inertial data.

Whenever a fingerprint recognition is performed, the raw inertial sensor data recorded for some seconds before, during, and after the fingerprint recognition are saved and stored to a local permanent memory; The term “permanent memory” is used to identify a data storage area in the device that is able to maintain the data available also in the case the device is turned off, and until the data are transmitted to the backend. So, it is in facts a temporary storage, which is “permanent” in the sense previously defined, i.e., data are retained through a power off/power on cycle.

If a liveness detection algorithm or other single sensor authenticity check algorithm is applied on the smartphone/tablet, the results of such algorithm are also saved to a local permanent memory.

The data saved to the local permanent memory, duly tagged with timestamp references, are sent to the Backend system, either immediately or at a later time.

The movement of the smartphone/tablet occurred for some seconds before, during, and after the fingerprint recognition is then reconstructed from the raw inertial data collected, using any trajectory reconstruction algorithms available in the literature. This reconstruction is a form of data summarisation and aggregation that may occur either locally on the smartphone/tablet (and then the reconstructed trajectory is saved and sent to the backend system) or on the Backend system (based on the raw inertial sensor data received from the smartphone/tablet).

For each of the fingerprint recognitions made by the user, the Backend system stores the above data into a database, for later processing in the case a certain fingerprint recognition is disputed.

Whenever a fingerprint recognition is disputed, the Backend system retrieves from the database data collected for each fingerprint recognition made for the same user with the same smartphone/tablet. Smartphone trajectories collected are compared with each other and with the trajectory recorded for the disputed recognition, and a degree of similarity is calculated between the trajectory recorded for the disputed recognition and all trajectories recorded for other recognitions using any techniques (e.g., cross-correlation, pattern recognition) that allow evaluation as to whether such trajectories, considered as movement functions, are similar or not. Artificial Intelligence algorithms for pattern recognition may be also used to this purpose.

The outcome of the above algorithm is an assessment concerning the way the smartphone/tablet was moved when the fingerprint recognition was carried out. It is likely that, when the legitimate user performs a fingerprint recognition, he/she moves the smartphone/tablet in a specific way (e.g., slightly rotates the smartphone left or right) so as to facilitate the presentation of the finger to fingerprint sensor. If a spoofed fingerprint was used, the movement performed will be likely different, and therefore such anomalous movement may be recognised based on the lack of similarity with other (supposedly non-spoofed) recognitions. The results of liveliness detection or other single sensor authenticity check algorithms (either performed originally on the smartphone, or computed/re-computed on the Backend systems) may also be combined with results of the calculation of the degree of similarity of the smartphone/table's trajectory so as to obtain a more accurate assessment regarding the estimated authenticity of the recognition.

As a further example within the scope of the present invention, data originated from a single sensor fingerprint recognition system may be combined with data provided by the RF interfaces that are present in all smartphones/tablets/laptops. An example of the algorithm to combine data from both sensors is the following.

Whenever a fingerprint recognition is performed, the RF interfaces of the smartphone/tablet/laptop are activated so that data representing the current RF environment surrounding the device are collected, such as: ID of the GSM cells received; SSID of the WiFi networks received; Bluetooth address of any Bluetooth device in the surroundings that is in advertising mode; GNSS position if available, or last GNSS position known if available. Such “RF snapshot information” relevant to the current RF environment are saved to a local permanent memory of the device.

If a liveness detection algorithm or other single sensor authenticity check algorithm is applied on the device, the results of such algorithm are also saved to a local permanent memory.

The data saved to the local permanent memory, duly tagged with timestamp references, are sent to the Backend system, either immediately or at a later time.

For each fingerprint recognition made by the user, the Backend system stores the above data into a database, for later processing in the case a certain fingerprint recognition is disputed.

Whenever a fingerprint recognition is disputed, the Backend system retrieves from the database data collected for each and fingerprint recognitions made for the same user with the same device. RF snapshot information collected are compared among them and with the RF snapshot recorded for the disputed recognition, and a degree of similarity is calculated between the RF snapshot recorded for the disputed recognition and all RF snapshots recorded for other recognitions, using any techniques that allow to evaluate whether such RF snapshots are similar or not.

The outcome of the above algorithm is an assessment concerning the RF environment surrounding the device when the fingerprint recognition was carried out, to evaluate whether such RF environment is credible with respect to the other RF environments normally experienced by that user and by that device. The results of liveliness detection or other single sensor authenticity check algorithms (either performed originally on the smartphone, or computed/re-computed on the Backend systems) may also be combined with results of the calculation of the degree of similarity of the RF snapshots so as to obtain a more accurate assessment regarding the estimated authenticity of the recognition.

As a further example, data originated from a single sensor fingerprint recognition system may be combined with data provided by cameras (front and/or rear) that are present in all modern smartphones and tablets. The algorithm envisaged to combine data from both sensors is as followings.

Raw image data from the camera(s) are continuously collected and stored in a circular memory that is large enough to store several seconds of raw data.

Whenever a fingerprint recognition is performed, the raw image data recorded for some seconds before, during, and after the fingerprint recognition are saved and stored to a local permanent memory.

If a liveness detection algorithm or other single sensor authenticity check algorithm is applied on the smartphone/tablet, the results of such algorithm are also saved to a local permanent memory.

The data saved to the local permanent memory, duly tagged with timestamp references, are sent to the Backend system, either immediately or at a later time.

The raw image data collected are processed in order to reconstruct both the movement of the smartphone/tablet occurred for some seconds before, during, and after the fingerprint recognition (similarly to the inertial sensor case, using apparent movement on the images in lieu of inertial data) and to identify visual elements (objects, faces, background characteristics, etc.) that are present in the surroundings. These reconstructions and identifications are forms of data summarisation and aggregation that may occur either locally on the smartphone/tablet (and then the reconstructed trajectory and identified elements are saved and sent to the backend system) or on the Backend system (based on the raw image data received from the smartphone/tablet).

For each and all the fingerprint recognitions made by the user, the Backend system stores the above data into a database, for later processing in the case a certain fingerprint recognition is disputed.

Whenever a fingerprint recognition is disputed, the Backend system retrieves from the database all data collected for each and all fingerprint recognitions made for the same user with the same smartphone/tablet. All smartphone/tablet trajectories and all identified visual elements collected are compared among them and with the data recorded for the disputed recognition, and a degree of similarity is calculated between the data recorded for the disputed recognition and all data recorded for other recognitions whether such data are similar or not.

The outcome of the above algorithm is, again, an assessment concerning the way the smartphone/tablet was moved and what visual elements were present when the fingerprint recognition was carried out in comparison with the corresponding data collected during other (supposedly non-spoofed) recognitions.

Verification of Authentication Based on Facial Recognition

In the case of facial recognition, as in the case of fingerprint recognition, several techniques are known to submit an artificial/approximate reconstruction of the face of a real person to a facial recognition system, and obtain that the face is recognised as if it were the face of the actual person. As in the case of fingerprint recognition, algorithms have been developed (including specific liveness detection algorithms, based on checking movements such as blinks or dilation of the pupils when submitted to a variation of light intensity) to reduce the probability that a facial recognition spoofing attempt results in a successful fraudulent authentication. However, no algorithms of this type are 100% reliable yet, and a residual probability remains that a fraudulent authentication occurs, even when the most sophisticated authenticity check algorithms are used.

As described already about fingerprint recognition, a key characteristic of the present examples is that data from a single sensor facial recognition system (i.e., a traditional system that makes use of one or more cameras) are combined with data originated from other sensors so as to improve the performance of the overall authenticity check whenever the authenticity of a facial recognition is disputed.

As an example, data originated from a single sensor facial recognition system may be combined with data provided by the inertial sensor (accelerometer and/or gyroscope) that is present in most modern smartphones and tablets. The algorithm envisaged to combine data from both sensors is as followings.

Raw data from the inertial sensor (3-axes acceleration and/or 3-axes angular speed) are continuously collected and stored in a circular memory that is large enough to store several seconds of raw inertial data.

Whenever a facial recognition is performed, the raw inertial sensor data recorded for some seconds before, during, and after the facial recognition are saved and stored to a local permanent memory.

If a liveness detection algorithm or other single sensor authenticity check algorithm is applied on the smartphone/tablet, the results of such algorithm are also saved to a local permanent memory.

The data saved to the local permanent memory, duly tagged with timestamp references, are sent to the Backend system, either immediately or at a later time.

The movement of the smartphone/tablet occurred for some seconds before, during, and after the facial recognition is then reconstructed from the raw inertial data collected, using any trajectory reconstruction algorithms available in the literature. This reconstruction is a form of data summarisation and aggregation that may occur either locally on the smartphone/tablet (and then the reconstructed trajectory is saved and sent to the backend system) or on the Backend system (based on the raw inertial sensor data received from the smartphone/tablet).

For each facial recognition made by the user, the Backend system stores the above data into a database, for later processing in the case a certain facial recognition is disputed.

Whenever a facial recognition is disputed, the Backend system retrieves from the database all data collected for each and all facial recognitions made for the same user with the same smartphone/tablet. All smartphone trajectories collected are compared among them and with the trajectory recorded for the disputed recognition, and a degree of similarity is calculated between the trajectory recorded for the disputed recognition and all trajectories recorded for other recognitions using any techniques (e.g., cross-correlation, pattern recognition) that allow to evaluate whether such trajectories, considered as movement functions, are similar or not. Artificial Intelligence algorithms for pattern recognition may be also used to this purpose.

The outcome of the above algorithm is an assessment concerning the way the smartphone/tablet was moved when the facial recognition was carried out. It is likely that, when the legitimate user performs a facial recognition, he/she moves the smartphone/tablet in a specific way (e.g., slightly rotates the smartphone left or right) so as to facilitate the presentation of the face to the cameras. If a spoofed facial image was used, the movement performed will be likely different, and therefore such anomalous movement may be recognised based on the lack of similarity with other (supposedly non-spoofed) recognitions. The results of other single sensor authenticity check algorithms (either performed originally on the smartphone, or computed/re-computed on the Backend systems) may also be combined with results of the calculation of the degree of similarity of the smartphone/tablet's trajectory so as to obtain a more accurate assessment regarding the estimated authenticity of the recognition.

As a further example, data originated from a single sensor facial recognition system may be combined with data provided by the RF interfaces that are present in all smartphones/tablets/laptops. The algorithm envisaged to combine data from both sensors is as following.

Whenever a facial recognition is performed, the RF interfaces of the smartphone/tablet/laptop are activated so that data representing the current RF environment surrounding the device are collected, such as: ID of the GSM cells received; SSID of the WiFi networks received; Bluetooth address of any Bluetooth device in the surroundings that is in advertising mode; GNSS position if available, or last GNSS position known if available. Such “RF snapshot information” relevant to the current RF environment are saved to a local permanent memory of the device.

If a liveness detection algorithm or other single sensor authenticity check algorithm is applied on the device, the results of such algorithm are also saved to a local permanent memory.

The data saved to the local permanent memory, duly tagged with timestamp references, are sent to the Backend system, either immediately or at a later time.

For each facial recognition made by the user, the Backend system stores the above data into a database, for later processing in the case a certain facial recognition is disputed.

Whenever a facial recognition is disputed, the Backend system retrieves from the database all data collected for each and all facial recognitions made for the same user with the same device. All RF snapshot information collected are compared among them and with the RF snapshot recorded for the disputed recognition, and a degree of similarity is calculated between the RF snapshot recorded for the disputed recognition and RF snapshots recorded for other recognitions, using any techniques that allow to evaluate whether such RF snapshots are similar or not.

The outcome of the above algorithm is an assessment concerning the RF environment surrounding the device when the facial recognition was carried out, to evaluate whether such RF environment is credible with respect to the other RF environments normally experienced by that user and by that device. The results of liveliness detection or other single sensor authenticity check algorithms (either performed originally on the smartphone, or computed/re-computed on the Backend systems) may also be combined with results of the calculation of the degree of similarity of the RF snapshots so as to obtain a more accurate assessment regarding the estimated authenticity of the recognition.

Verification of Authentication Based on Speaker Recognition

In the case of speaker recognition, too, several techniques are known to obtain that a voice (either imitated, synthesized or recorded) is recognised as if it were the voice of an actual, specific person. And, therefore, algorithms have been developed (such as liveness detection algorithms that require to answer different questions) to reduce the probability that a speaker recognition spoofing attempt results in a successful fraudulent authentication. However, once again, no algorithms of this type are 100% reliable yet, and a residual probability remains that a fraudulent authentication occurs, even when the most sophisticated authenticity check algorithms are used.

As described already about fingerprint and facial recognition, a key characteristic of the present examples is that data from a speaker recognition system (i.e., a traditional system that makes use of one or more microphones) are combined with data originated from other sensors so as to improve the performance of the overall authenticity check whenever the authenticity of a speaker recognition is disputed.

As an example, data originated from a (single sensor) speaker recognition system may be combined with data provided by the inertial sensor (accelerometer and/or gyroscope) that is present in most modern smartphones and tablets. The algorithm envisaged to combine data from both sensors is as followings.

Raw data from the inertial sensor (3-axes acceleration and/or 3-axes angular speed) are continuously collected and stored in a circular memory that is large enough to store several seconds of raw inertial data.

Whenever a speaker recognition is performed, the raw inertial sensor data recorded for some seconds before, during, and after the speaker recognition are saved and stored to a local permanent memory.

If a liveness detection algorithm or other single sensor authenticity check algorithm is applied on the smartphone/tablet, the results of such algorithm are also saved to a local permanent memory.

The data saved to the local permanent memory, duly tagged with timestamp references, are sent to the Backend system, either immediately or at a later time.

The movement of the smartphone/tablet occurred for some seconds before, during, and after the speaker recognition is then reconstructed from the raw inertial data collected, using any trajectory reconstruction algorithms available in the literature. This reconstruction is a form of data summarisation and aggregation that may occur either locally on the smartphone/tablet (and then the reconstructed trajectory is saved and sent to the backend system) or on the Backend system (based on the raw inertial sensor data received from the smartphone/tablet).

For each and all the speaker recognitions made by the user, the Backend system stores the above data into a database, for later processing in the case a certain speaker recognition is disputed.

Whenever a speaker recognition is disputed, the Backend system retrieves from the database all data collected for each and all speaker recognitions made for the same user with the same smartphone/tablet. All smartphone trajectories collected are compared among them and with the trajectory recorded for the disputed recognition, and a degree of similarity is calculated between the trajectory recorded for the disputed recognition and all trajectories recorded for other recognitions using any techniques (e.g., cross-correlation, pattern recognition) that allow to evaluate whether such trajectories, considered as movement functions, are similar or not. Artificial Intelligence algorithms for pattern recognition may be also used to this purpose.

The outcome of the above algorithm is an assessment concerning the way the smartphone/tablet was moved when the speaker recognition was carried out. It is likely that, when the legitimate user performs a speaker recognition, he/she moves the smartphone/tablet in a specific way (e.g., slightly rotates the smartphone left or right, or up or down) so as to facilitate the presentation of the voice to the microphone. If a spoofed voice was used, the movement performed will be likely different, and therefore such anomalous movement may be recognised based on the lack of similarity with other (supposedly non-spoofed) recognitions. The results of other authenticity check algorithms (either performed originally on the smartphone, or computed/re-computed on the Backend systems) may also be combined with results of the calculation of the degree of similarity of the smartphone/tablet's trajectory so as to obtain a more accurate assessment regarding the estimated authenticity of the recognition.

As a further example, data originated from a speaker recognition system may be combined with data provided by the RF interfaces that are present in all smartphones/tablets/laptops. The algorithm envisaged to combine data from both sensors is as following.

Whenever a speaker recognition is performed, the RF interfaces of the smartphone/tablet/laptop are activated so that data representing the current RF environment surrounding the device are collected, such as: ID of the GSM cells received; SSID of the WiFi networks received; Bluetooth address of any Bluetooth device in the surroundings that is in advertising mode; GNSS position if available, or last GNSS position known if available. Such “RF snapshot information” relevant to the current RF environment are saved to a local permanent memory of the device.

If a liveness detection algorithm or other single sensor authenticity check algorithm is applied on the device, the results of such algorithm are also saved to a local permanent memory.

The data saved to the local permanent memory, duly tagged with timestamp references, are sent to the Backend system, either immediately or at a later time.

For each and all the speaker recognitions made by the user, the Backend system stores the above data into a database, for later processing in the case a certain speaker recognition is disputed.

Whenever a speaker recognition is disputed, the Backend system retrieves from the database all data collected for each and all speaker recognitions made for the same user with the same device. All RF snapshot information collected are compared among them and with the RF snapshot recorded for the disputed recognition, and a degree of similarity is calculated between the RF snapshot recorded for the disputed recognition and all RF snapshots recorded for other recognitions, using any techniques that allow to evaluate whether such RF snapshots are similar or not.

The outcome of the above algorithm is an assessment concerning the RF environment surrounding the device when the speaker recognition was carried out, to evaluate whether such RF environment is credible with respect to the other RF environments normally experienced by that user and by that device. The results of liveliness detection or other authenticity check algorithms (either performed originally on the smartphone, or computed/re-computed on the Backend systems) may also be combined with results of the calculation of the degree of similarity of the RF snapshots so as to obtain a more accurate assessment regarding the estimated authenticity of the recognition.

As a further example within the scope of the present invention, data originated from a speaker recognition system may be combined with data provided by cameras (front and/or rear) that are present in all modern smartphones and tablets. The algorithm envisaged to combine data from both sensors is as followings.

Raw image data from the camera(s) are continuously collected and stored in a circular memory that is large enough to store several seconds of raw data;

Whenever a speaker recognition is performed, the raw image data recorded for some seconds before, during, and after the speaker recognition are saved and stored to a local permanent memory.

If a liveness detection algorithm or other single sensor authenticity check algorithm is applied on the smartphone/tablet, the results of such algorithm are also saved to a local permanent memory.

The data saved to the local permanent memory, duly tagged with timestamp references, are sent to the Backend system, either immediately or at a later time.

The raw image data collected are processed in order to reconstruct both the movement of the smartphone/tablet occurred for some seconds before, during, and after the speaker recognition (similarly to the inertial sensor case, using apparent movement on the images in lieu of inertial data) and to identify visual elements (objects, faces, background characteristics, etc.) that are present in the surroundings. These reconstructions and identifications are forms of data summarisation and aggregation that may occur either locally on the smartphone/tablet (and then the reconstructed trajectory and identified elements are saved and sent to the backend system) or on the Backend system (based on the raw image data received from the smartphone/tablet).

For each and all the speaker recognitions made by the user, the Backend system stores the above data into a database, for later processing in the case a certain speaker recognition is disputed.

Whenever a speaker recognition is disputed, the Backend system retrieves from the database all data collected for each and all speaker recognitions made for the same user with the same smartphone/tablet. All smartphone/tablet trajectories and all identified visual elements collected are compared among them and with the data recorded for the disputed recognition, and a degree of similarity is calculated between the data recorded for the disputed recognition and all data recorded for other recognitions whether such data are similar or not.

The outcome of the above algorithm is, again, an assessment concerning the way the smartphone/tablet was moved and what visual elements were present when the speaker recognition was carried out in comparison with the corresponding data collected during other (supposedly non-spoofed) recognitions.

Data Collection and Transmission for Authentication Verification

The process of collecting data on a user device (smartphone, tablet, computer, etc.) and sending such data to a backend system for authentication verification may be carried out using a so-called Software Development Kit (SDK) that can be invoked inside a mobile App, and that takes care of collecting and sending the data to the backend at due time. The data collected are initially stored locally on the mobile device's memory, before then being sent to the backend in batches when appropriate, through a software function of the SDK that is usually known as dispatching. In one example, the dispatching may occur once every 30 minutes, and in another example once every 2 minutes. The frequency can be customised depending on the specific application.

In the example of a user device being a personal computer, snippets of JavaScript code may collect and send data to the backend system, the data sent being those that are significant for the intended authentication verification purposes (e.g., inertial sensor data, RF sensors data, camera data, etc.). In the case of a user device being a mobile phone, a specific SDK may be used, developed for this specific application, that collects and dispatches the relevant data types. For the purpose of verification of disputed authentications, the dispatching is done quite frequently, for example every 2 minutes or more frequently, as one of the possible ways to prevent that an authentication verification is carried out may be to turn off or possibly damage/destroy the mobile device before the data pursuant to a fraudulent authentication are sent to the backend. However, the fact that data pursuant to a disputed authentication are not available because the device was turned off or destroyed may itself be a sign that a fraudulent authentication was carried out.

Examples of Signal Flow Between Modules

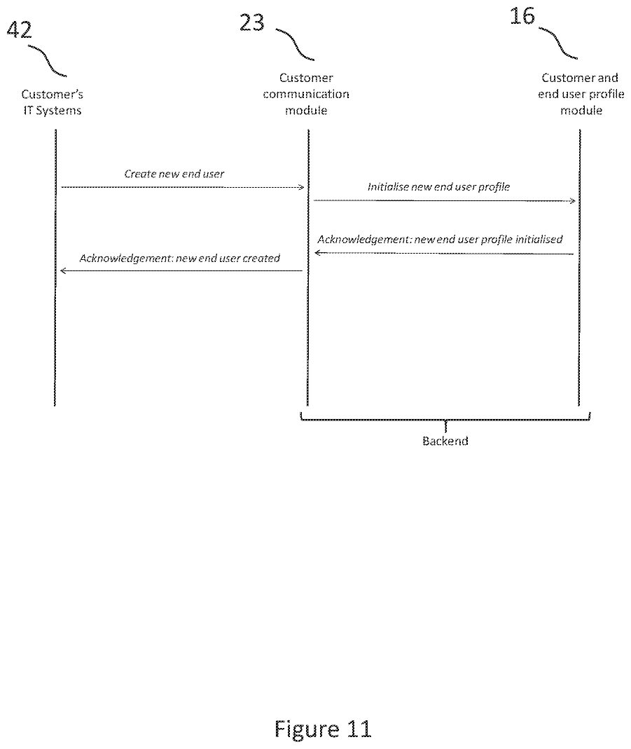

FIG. 11 shows a collaboration diagram relevant to the activation of a new user. The user or end user is typically the person who is supposed to perform the interaction through a user device. This person may be, for example, the customer of the bank or of a credit card organisation or other organisation that makes use of the interaction verification method to possibly validate disputed interactions.

The customer is typically the bank, credit card organisation, or other organisation (e.g., a service provider providing the interaction verification service to other organisations) that makes use of the interaction verification method to possibly validate disputed interactions.

As shown in FIG. 11, when a new end user is activated by a customer (e.g., a new bank account or credit card holder) the first communication occurs between the customer's IT systems 42 and the customer communication module 23. The customer's IT systems, through the communication interface, inform the interaction verification system that a new end user has to be added, and all relevant information (configuration settings for data collection, data transmission, privacy consent, parameters for SSO through the App, etc.) are provided to the customer communication module, which then communicates with the customer and end user profile module 16 so that a user profile is created for the user in subject and permanently stored. The completion of the operation is then acknowledged through the system to the originator.

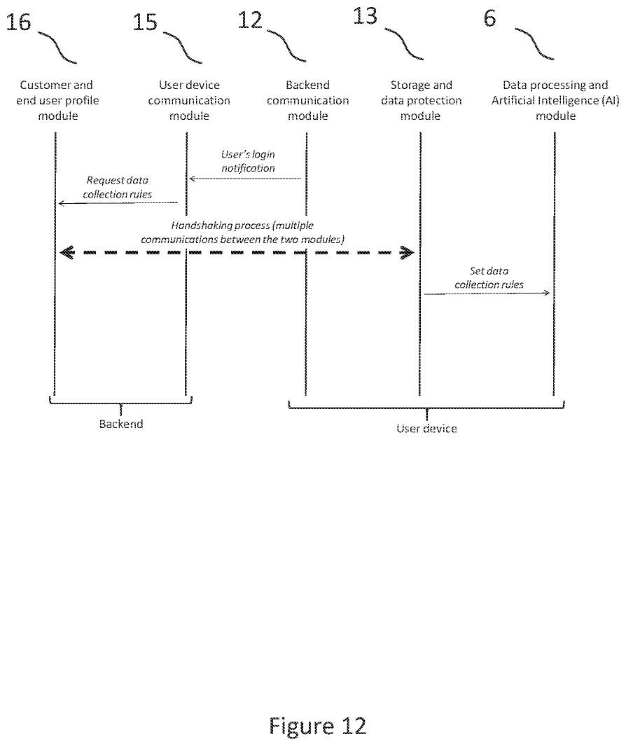

Then, the user is supposed to download the customer's app (or equivalent customer application software to be run on the user device). The user device modules for interaction verification are integrated in the customer application software as a SDK. The end user logins to the customer's application and, through SSO, the end user is also identified and logged-in for the interaction verification functions. When this step occurs, further user initialisation functions are performed, as shown in FIG. 12.

Upon first login, a communication channel is established between the customer and end user profile module 16 in the backend and the storage and data protection module on the user device, with the involvement of the user device communication module 15 and of the backend communication module 12, so that the user device is programmed to collect and send data according to the defined rules (including the data processing rules defined by the data processing and artificial intelligence module on the backend side). This includes (shown with a larger dashed arrow in the diagram above) a handshaking between the two customer and end user profile modules (the one in the backend and the one on the user device side) so that information pursuant to the specific user device (e.g., which sensors are present on the device and which sensors are not present instead, what are the characteristics of the sensors, etc.) are added to the user profile, and the most appropriate data processing rules are selected accordingly. On the user device side, the customer and end user profile module 16 then instruct the data processing and artificial intelligence (AI) module 6 (user device side) about the data processing rules to be applied. If anything changes over time concerning the end user profile, including the data processing rules (e.g., based on data collected some improvements to the data processing rules may be introduced), all changes are propagated from the backend to the end user device or vice versa though the same handshaking mechanism.

Once the user device is completely initialised, all modules start collecting, processing, and possibly sending data to the backend as required by their own functions and by the defined user profile including the associated data processing rules. Whenever an interaction is made, data are handled as required, and a unique interaction ID is assigned to the interaction so that the interaction can be traced at a later time.

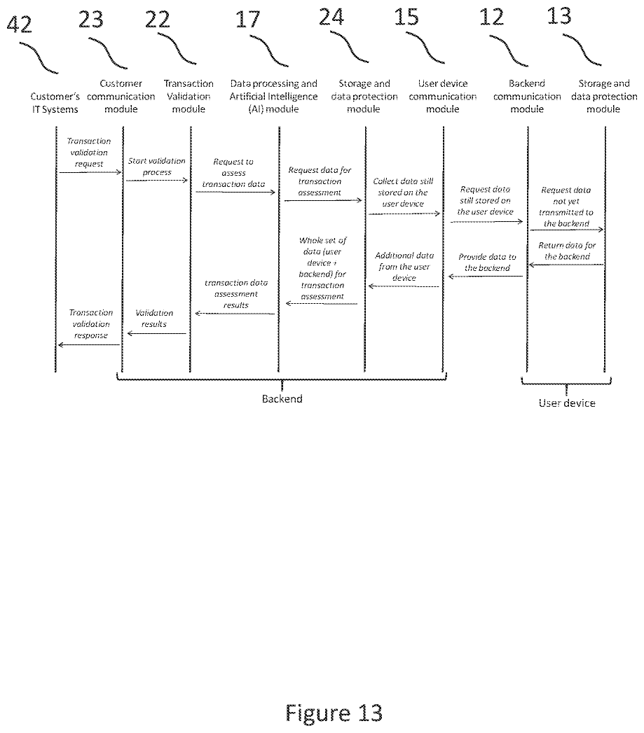

FIG. 13 shows the collaboration diagram relevant to a disputed interaction. When a disputed interaction occurs, the customer's IT systems 25, through the communication interface, submit to the customer communication module 23 a request of validating a certain interaction ID. The customer communication module 23 activates the interaction validation module 22, which activates the data processing and artificial intelligence (AI) module (backend side) 17, which in turns retrieves the required data from the Storage and data protection modules 24, 13 (the one on the backend side for data transmitted already to the backend, the one on the user device side for data not transmitted already to the backend). The data retrieval from the user device may not be immediate, as the user device may be off or not connected, so requests for data to be transmitted by the user device are queued for being honoured as soon as a connection to the end user device can be established. When data are available and the response from the interaction validation module is ready, the result is communicated to the customer's IT systems by the customer communication module.

The collaboration diagrams do not include the case where one backend is shared among multiple customers, such as, for example, the case where an interaction validation service is provided by an independent entity (i.e., an interaction Validation Service Provider—TVSP) to multiple customers (various banks, credit card organisations, online payment providers, etc.). A TVSP approach may be valuable because sharing many end users from multiple customers provides larger datasets to test and fine tune the data processing systems, and, in the case of artificial intelligence systems, it provides larger datasets to train and test the AI algorithms Backend system arrangements

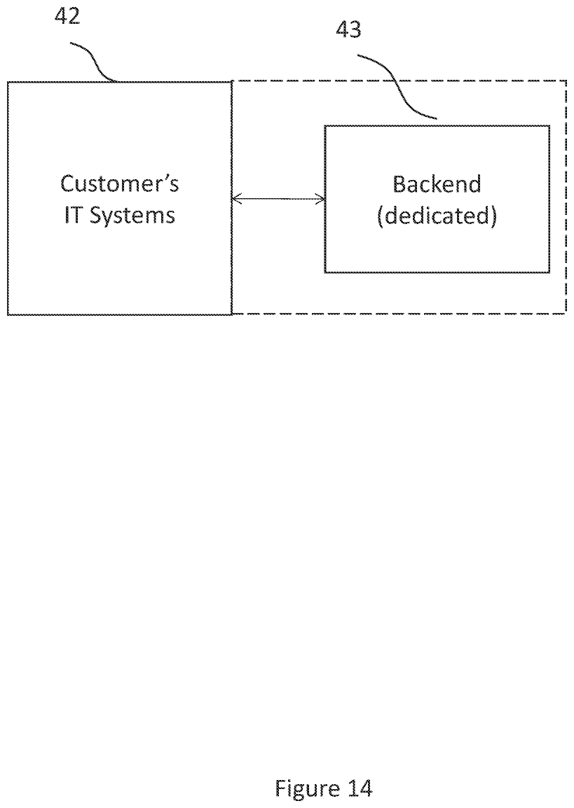

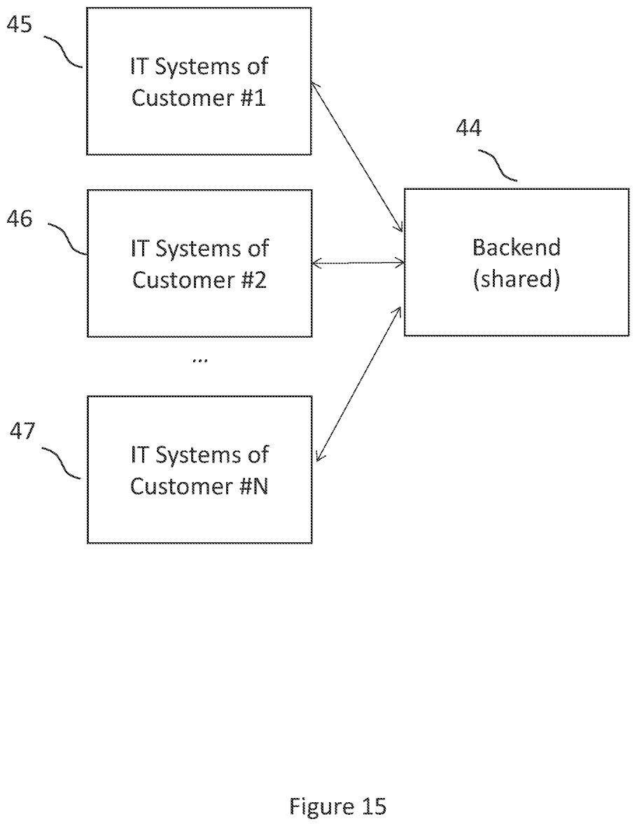

Two example backend system arrangements (dedicated and shared backend) are depicted in FIGS. 14 and 15.

In the case of dedicated backend, as illustrated in FIG. 14, the backend itself 26 may be logically considered as a part of the customer's IT systems 25, especially if it is co-located and physically integrated with them.

In the case of shared backend, in the case of FIG. 15, the logical differentiation between the backend 27 and the various customers' IT systems is important, regardless they are physically co-located or even when they share the same cloud servers. In this case the customer communication module is logically and physically connected to the IT systems of multiple customers 28, 29, 30, and it is prepared to receive interaction validation requests from each of them. It provides the relevant responses maintaining the necessary logical separation between requests originated by different customers.

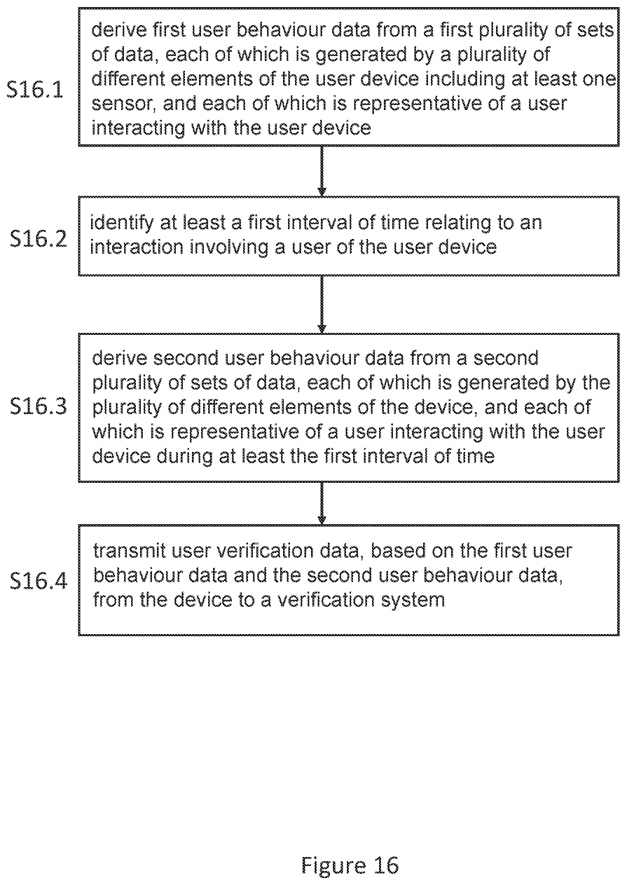

FIG. 16 is a flow diagram showing a method of processing data in a user device to generate user verification data for use in an interaction verification system, according to steps S16.1, S16.2, S16.3 and S16.4.

In the examples already described, the interaction may be a transaction, for example a transaction comprising a financial transaction, and the interaction verification system may be referred to as a transaction verification system. The examples may relate to verification of a transaction and to a method of processing data in a user device to generate user verification data for use in a transaction verification system, and to a system for verification of a transaction after the transaction has taken place. The computer recognition of a user may be an identity check. In an example, there is provided a method of processing data in a user device to generate user verification data for use in a transaction verification system, comprising: deriving first user behaviour data from a first plurality of sets of data, each of which is generated by a plurality of different elements of the user device, and each of which is representative of a user interacting with the user device; identifying at least a first interval of time relating to a transaction involving a user of the user device; deriving second user behaviour data from a second plurality of sets of data, each of which is generated by the plurality of different elements of the device, and each of which is representative of a user interacting with the user device during at least the first interval of time; and transmitting user verification data, comprising the first user behaviour data and the second user behaviour data, from the device to a transaction verification system. This allows the verification system to process the first user behaviour data and the second behaviour data, for example for investigation of a disputed transaction, to determine a likelihood that the disputed transaction involved interaction of a given user with the device.

It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

We claim:

1. A computer-implemented method for enabling computer recognition of a user interacting with a user device in an identified interval of time by processing data at the user device to produce user verification data for use in an interaction verification system, comprising:
deriving first user behaviour data by processing a first plurality of sets of data, each of which is generated by a plurality of different elements of the user device, the plurality of different elements including at least one sensor, and each of which is representative of a user interacting with the user device;
identifying at least a first interval of time relating to an interaction of a user of the user device with the user device;
deriving second user behaviour data by processing a second plurality of sets of data, each of which is generated by the plurality of different elements of the device, the plurality of different elements including at least one sensor, and each of which is representative of a user interacting with the user device during at least the first interval of time; and
transmitting user verification data, based on the first user behaviour data and the second user behaviour data, from the user device to an interaction verification system.

2. The method of claim 1, comprising identifying the first interval of time as an interval of time during which the interaction occurs.

3. The method of claim 2, comprising:
identifying a second interval of time as an interval of time before which the interaction occurs and/or
identifying a third interval of time as an interval of time after which the interaction occurs,
wherein the second plurality of sets of data is each representative of a user interacting with the device during the first interval of time and the second and/or the third interval of time.

4. The method of claim 1, comprising collecting the second user behaviour data in response to receiving an indication that an interaction is in progress.

5. The method of claim 1, comprising:
storing the second user behaviour data in a storage system on the user device;
receiving timing data indicative of the first interval of time from the interaction verification system; and
retrieving the second user behaviour data from the storage system on the basis of the timing data.

6. The method of claim 1, wherein deriving the first and second user behaviour data comprises use of a hardware abstraction functional module configured to transform data generated by the plurality of different elements of the user device into transformed element data having a normalised format.

7. The method of claim 6, wherein deriving the first and second user behaviour data comprises use of a data processing functional module configured to perform summarisation, aggregation and combination functions on the transformed element data to generate processed element data.

8. The method of claim 7, wherein deriving the first user behaviour data comprises use of a user behaviour functional module configured to extract information about typical behaviour of a user from processed element data relating to the first plurality of sets of data.

9. The method of claim 8, wherein deriving the second user behaviour data comprises use of a behaviour functional module configured to extract information about the behaviour of a user from processed element data relating to the second plurality of sets of data.

10. The method of claim 1, wherein the user verification data comprises an output from a machine learning model, wherein parameters for the machine learning model are received from the validation system.

11. The method of claim 10, wherein an input to the machine learning model comprises the first user behaviour data and the second user behaviour data and the user verification data comprises an output of the machine learning model.

12. The method of claim 11, wherein the output of the machine learning model comprises a probability that a user in the first interval of time is different from a user corresponding to the first user behaviour data.

13. The method of claim 12, wherein the machine learning model is a deep neural network, DNN, wherein the deep neural network has been trained to detect an anomalous interval of time in a series of intervals of time.

14. The method of claim 13, wherein an input to the machine learning model comprises at least the first set of data and the second set of data and an output of the machine learning model comprises the first user behaviour and the second user behaviour data.

15. The method of claim 14, wherein the machine learning model has been trained by using unsupervised learning to sort interactions in trial data into clusters, wherein the machine learning model processes individual time intervals to estimate to which cluster the time interval belongs, and wherein the user verification data comprises an estimate of to which cluster the time interval belongs.

16. A user device comprising one or more processors configured to perform a method for enabling recognition of a user interacting with a user device in an identified interval of time by processing data at the user device to produce user verification data for use in an interaction verification system, comprising:
deriving first user behaviour data by processing a first plurality of sets of data, each of which is generated by a plurality of different elements of the user device, the plurality of different elements including at least one sensor, and each of which is representative of a user interacting with the user device;
identifying at least a first interval of time relating to an interaction of a user of the user device with the user device;
deriving second user behaviour data by processing a second plurality of sets of data, each of which is generated by the plurality of different elements of the device, the plurality of different elements including at least one sensor, and each of which is representative of a user interacting with the user device during at least the first interval of time; and
transmitting user verification data, based on the first user behaviour data and the second user behaviour data, from the user device to an interaction verification system

17. A non-transitory computer-readable storage medium holding instructions for causing one or more processors to perform the steps of a computer-implemented method for enabling computer recognition of a user interacting with a user device in an identified interval of time by processing data at the user device to produce user verification data for use in an interaction verification system, comprising:
deriving first user behaviour data by processing a first plurality of sets of data, each of which is generated by a plurality of different elements of the user device, the plurality of different elements including at least one sensor, and each of which is representative of a user interacting with the user device;
identifying at least a first interval of time relating to an interaction of a user of the user device with the user device;
deriving second user behaviour data by processing a second plurality of sets of data, each of which is generated by the plurality of different elements of the device, the plurality of different elements including at least one sensor, and each of which is representative of a user interacting with the user device during at least the first interval of time; and
transmitting user verification data, based on the first user behaviour data and the second user behaviour data, from the user device to an interaction verification system.

18. A system for verification of an interaction after the interaction has taken place comprising a at least one user device and an interaction verification system,
wherein the user device comprises one or more processors configured to perform the steps of a computer-implemented method for enabling computer recognition of a user interacting with a user device in an identified interval of time by processing data at the user device to produce user verification data for use in an interaction verification system, comprising:
deriving first user behaviour data by processing a first plurality of sets of data, each of which is generated by a plurality of different elements of the user device, the plurality of different elements including at least one sensor, and each of which is representative of a user interacting with the user device;
identifying at least a first interval of time relating to an interaction of a user of the user device with the user device;
deriving second user behaviour data by processing a second plurality of sets of data, each of which is generated by the plurality of different elements of the device, the plurality of different elements including at least one sensor, and each of which is representative of a user interacting with the user device during at least the first interval of time; and
transmitting user verification data, based on the first user behaviour data and the second user behaviour data, from the user device to an interaction verification system,
and wherein the interaction verification system comprises one or more processors configured to process the user verification data to provide a verification of a given interaction.

19. The system of claim 18, wherein the interaction verification system comprises a data processing module configured to determine data processing rules to be applied by the user device, and to send data indicating the data processing rules to the user device.

20. The system of claim 19, wherein the interaction verification system comprises a machine learning model for use in determining parameters for use in a corresponding machine learning model for a user device.
